(19) United States
(12) Patent Application Publication
(10) Pub. No.: US 2025/0377526 A1
(43) Pub. Date: Dec. 11, 2025

(54) IMAGING SYSTEMS, OBJECTIVE MODULES, AND COMBINATIONS OF ELEMENTS

(71) Applicant: NANJING UNIVERSITY, Nanjing (CN)

(72) Inventor: Xuhao HONG, Suzhou (CN)

(73) Assignee: NANJING UNIVERSITY, Nanjing (CN)

(21) Appl. No.: 19/300,715

(22) Filed: Aug. 15, 2025

Related U.S. Application Data
(63) Continuation of application No. PCT/CN2024/077834, filed on Feb. 20, 2024.

(30) Foreign Application Priority Data
Feb. 20, 2023 (CN) 202310138919.6
Sep. 20, 2023 (CN) 202311221510.7
Sep. 20, 2023 (CN) 202311222612.0
Oct. 23, 2023 (CN) 202311379043.0

(51) Int. Cl. G02B 21/00; G02B 13/00; G02B 21/36

(52) U.S. Cl. CPC G02B 21/0056; G02B 13/0095; G02B 21/0032; G02B 21/362

(57) ABSTRACT

Example embodiments of present disclosure provide an imaging system, an objective lens module and a combination of elements. The imaging system, arranged along an optical axis from an object side to an image side, includes: a light source, configured to provide light for illuminating a sample; an imaging lens group, configured to receive the light exiting from the sample and perform at least one imaging for the sample; and a phase modulation unit, configured to modulate the light exiting from the imaging lens group, and obtain a desired sample image at an imaging plane of the imaging system.

### CROSS-REFERENCE TO RELATED APPLICATIONS

This application is a continuation of international application PCT/CN2024/077834 filed on Feb. 20, 2024, claiming priority to Chinese application No. 202310138919.6 filed on Feb. 20, 2023, claiming priority to Chinese application No. 202311221510.7 filed on Sep. 20, 2023, claiming priority to Chinese application No. 202311222612.0 filed on Sep. 20, 2023, and claiming priority to Chinese application No. 202311379043.0 filed on Oct. 23, 2023, the entire contents of which are incorporated herein by reference.

### TECHNICAL FIELD

The disclosure relates to the field of optical imaging technology, and in particular to an imaging system, an objective lens module, and a combination of elements.

### BACKGROUND

In order to achieve an optical microscopic observation of a sample with low-contrast and transparency such as a biological, a phase factor of the sample plays a key role. In the field of microscopes, the current mainstream microscopes, such as a phase contrast microscope, a Hoffman phase contrast microscope, or a differential interference microscope, etc., are used to achieve observation of the low-contrast sample by highlighting phase information of the low-contrast sample.

However, an imaging effect of the above types of microscopes is limited, and in order to achieve both an edge-enhanced imaging effect and a relief imaging effect in an imaging system, a 4f-based spiral phase contrast imaging system is proposed. The 4f-based spiral phase contrast imaging system utilizes a pair of confocal lenses, and filters by utilizing a spatial light modulator with spiral phase in the imaging optical path, thus ultimately achieving edge enhancement or relief imaging on the imaging plane.

However, the 4f-based spiral phase contrast imaging system does not have a high imaging resolution and has a certain optical aberration, and further requires adjustment to the original imaging optical path, which is not easy to be integrated into the commercial optical imaging system.

Therefore, it is necessary to provide an imaging system, an objective lens module, and a combination of elements, which can avoid introducing an additional lens performing a Fourier transform, and enrich the imaging effect of the phase contrast microscope while ensuring the imaging quality of the phase contrast microscope on the premise of minimizing the modification to the original optical path.

### SUMMARY

One or more embodiments of the present disclosure provide an imaging system, wherein the imaging system includes, in sequence along an optical axis from an object side to an image side: a light source configured to provide light illuminating a sample; an imaging lens group configured to receive light emitted through the sample to image the sample at least once; and, a phase modulation unit configured to modulate the light emitted through the imaging lens group to form a desired image of the sample on the imaging plane of the imaging system.

One or more embodiments of the present disclosure provide an image acquisition device comprising an imaging system as described hereinbefore, and a photosensitive element, the photosensitive element having a photosensitive element surface overlapping with the imaging plane of the imaging system.

One or more embodiments of the present disclosure provide an objective lens module comprising: a housing; an imaging lens group, disposed within the housing and configured to receive light illuminated by a light source to and out of the sample to image the sample at least once; a phase modulation unit, disposed within the housing, configured to modulate light emitted through the imaging lens group to form a desired image of the sample on the imaging plane of the objective lens module; wherein the plane containing the phase modulation unit is a pair of conjugate planes with a plane containing the light source, and wherein, at least, the optical path between the plane containing the phase modulation unit and the imaging plane of the objective lens module is not introduced to undergo a Fourier-transformed lens or lens group.

One or more embodiments of the present disclosure provide a combination of elements comprising: a light source configured to provide light illuminated to a sample; and, an external module having an attachment portion, the attachment portion being connectable to an objective lens; wherein the external module also has a phase modulation unit; wherein when the external module is connected to the objective lens via the connecting portion, the phase modulation unit is configured to modulate light emitted through the objective lens to form a desired image of the sample on the imaging plane of the objective lens; wherein the phase modulation unit is located in a plane conjugate to a plane containing the light source and wherein, at least, the optical path between the phase modulation unit and the imaging plane of the objective lens is not introduced to perform a Fourier transform.

One or more embodiments of the present disclosure provide an external module applied to a combination as previously described, the external module comprising a housing for accommodating the phase modulation unit, the housing being provided with the connecting portion.

### BRIEF DESCRIPTION OF THE DRAWINGS

The disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an imaging optical path according to some embodiments of the present disclosure;

FIG. 2 is another schematic diagram illustrating an imaging optical path according to some embodiments of the present disclosure;

FIG. 3 is a schematic diagram illustrating a structure of a first housing and a second housing according to some embodiments of the present disclosure;

FIG. 4 is a schematic diagram illustrating a comparison of phase contrast micrographs at tenfold magnification according to some embodiments of the present disclosure;

FIG. 5 is a schematic diagram illustrating a comparison of phase contrast micrographs at twentyfold magnification according to some embodiments of the present disclosure;

FIG. 6 is a schematic diagram illustrating a comparison of phase contrast micrographs at fortyfold magnification according to some embodiments of the present disclosure;

FIG. 7 is a schematic diagram illustrating a structure of adjusting a phase modulation unit for centering and decentration according to some embodiments of the present disclosure;

FIG. 8 is a schematic diagram illustrating a structure of adjusting a front lens for centering and decentration according to some embodiments of the present disclosure;

FIG. 9 is another schematic diagram illustrating an imaging optical path according to some embodiments of the present disclosure;

FIG. 10 is a schematic diagram illustrating an imaging optical path according to some embodiments of the present disclosure;

FIG. 11 is a schematic diagram illustrating a structure of an image acquisition device according to some embodiments of the present disclosure;

FIG. 12 is a schematic diagram illustrating an objective lens module according to some embodiments of the present disclosure;

FIG. 13 is another schematic diagram illustrating an objective lens module according to some embodiments of the present disclosure;

FIG. 14 is a schematic diagram illustrating a comparison of a tumor cell sample observed by an objective lens module at tenfold magnification according to some embodiments of the present disclosure;

FIG. 15 is a schematic diagram illustrating a tumor cell sample observed by an objective lens module at twentyfold magnification when an image of a light source coincides with a center of a Spiral Phase Plate (SPP) according to some embodiments of the present disclosure;

FIG. 16 is a schematic diagram illustrating a tumor cell sample observed by an objective lens module at twentyfold magnification when an image of a light source coincides with a center of a Sample Focal Plane (SPP) according to some embodiments of the present disclosure;

FIG. 17 is a schematic diagram illustrating a comparison of an unstained plant rhizome slice observed by an objective lens module at tenfold magnification according to some embodiments of the present disclosure;

FIG. 18 is a schematic diagram illustrating a comparison of a diatom sample observed by an objective lens module at tenfold magnification according to some embodiments of the present disclosure;

FIG. 19 is a schematic diagram illustrating a combination of elements according to some embodiments of the present disclosure;

FIG. 20 is a schematic diagram illustrating a structure of a combination of elements coordinating with an objective lens according to some embodiments of the present disclosure;

FIG. 21 is a schematic diagram illustrating a structure of an external module according to some embodiments of the present disclosure;

FIG. 22 is a schematic diagram illustrating a structure of an external imaging module according to some embodiments of the present disclosure;

FIG. 23 is another schematic diagram illustrating a structure of an external imaging module according to some embodiments of the present disclosure;

FIG. 24 is another schematic diagram illustrating a comparison of phase contrast micrographs at tenfold magnification according to some embodiments of the present disclosure;

FIG. 25 is another schematic diagram illustrating a comparison of phase contrast micrographs at twentyfold magnification according to some embodiments of the present disclosure;

FIG. 26 is a schematic diagram illustrating a comparison of phase contrast micrographs at fiftyfold magnification according to some embodiments of the present disclosure; and

FIG. 27 is another schematic diagram illustrating a structure of a combination of elements according to some embodiments of the present disclosure.

### DETAILED DESCRIPTION

In order to make the technical solution and the beneficial effect of the present disclosure more obvious and understandable, the following is a detailed description by way of enumerating specific embodiments. The accompanying drawings are not necessarily drawn to scale, and local features may be enlarged or reduced to show the details of the local features more clearly; and, unless otherwise defined, technical and scientific terms used in the present disclosure are consistent with the technical and scientific terms in the field of technology to which the present disclosure belongs.

In addition, the terms “first” and “second” are used for descriptive purposes only and are not to be construed as indicating or implying relative importance or implicitly specifying a particular feature. Thereby, the feature defined as “first” or “second” may expressly or implicitly include at least one such feature. In the description of the present disclosure, “plurality” means at least two, e.g., two, three, or the plurality of other values, unless explicitly and specifically limited otherwise.

It should be noted that when an element is said to be “fixed to” or “arranged with” another element, the element may be directly on another element or there may be at least one centered element between the element and the another element. When an element is said to be “connected” to another element, the element may be directly connected to the another element or there may be at least one centered element between the element and the another element at the same time.

In the present disclosure, a side of a space on which an object is located with respect to an optical element is referred to as an object side of the optical element, and a side of a space on which an image of the object is located with respect to the optical element is referred to as an image side of the optical element. In the present disclosure, “adjacent” means that no element arranged between an element and other elements, between an element and an object plane, and between an element and an imaging plane in an imaging system without considering a diaphragm. In the present disclosure, a light source may include an entity that emits light itself, or include an entity (e.g., a reflector) that reflects incident light to enable the incident light to illuminate a sample.

In the present disclosure, the phase modulation unit may include one or more of a Spiral Phase Plate (SPP), a holographic grating, a mode converter containing a spherical lens and a column lens, a spatial light modulator, etc. The spiral phase plate, also known as a Helical phase plate (HPP), an optical vortex element, or a Bessel amplitude modulated spiral phase plate, converts input Gaussian beam to an energy circular ring (i.e., generating the optical vortex beam), and a structure of the spiral phase plate is similar to a shape of helix or spiral ladder, which is designed for controlling phases of the optical vortex beam. The spiral phase plate is a common manner for obtaining the optical vortex beam, and a technician may change a spot diameter and a topological charge of the optical vortex beam by adjusting design parameters of the spiral phase plate to satisfy the need of different applications. It can be understood that there are many manners for generating the optical vortex beam besides using the spiral phase plate. For example, the holographic grating is used to generate the optical vortex beam from low order Gaussian beam. As another example, the mode converter containing a spherical lens and a column lens may also be used to obtain the optical vortex beams from high-order Hermitian Gaussian beam. As another example, the spatial light modulator is chosen to generate the optical vortex beams, etc.

In order to achieve a micro stereoscopic imaging of a transparent sample, technicians may use a phase contrast microscope, a Hoffman phase contrast microscope, a differential interference microscope, etc., to highlight phase information of the transparent sample to observe the transparent sample. Specifically, the phase contrast microscope uses a transmission ring in the light source and a dark field phase ring on a back focal plane of the objective lens to convert the phase information to amplitude information based on an Abbe imaging principle, so as to observe the transparent sample; the Hoffman phase contrast microscope uses an oblique incident light source paired with a Hoffman grayscale filter to obtain three-dimensional topography information of the transparent sample; and the differential interference microscope uses two incident light beams with a slight offset to illuminate the sample, carrying phase gradient information of the sample, which is then integrated into intensity information presented in a final image. Therefore, a position of the sample with a phase gradient may appear different from a light intensity distribution of a flat area, revealing an effect similar to relief.

However, the imaging effect of the above microscopes is limited. For example, the phase contrast microscope is typically used to achieve an imaging effect of edge enhancement, the Hoffman phase contrast microscope is typically used to achieve an imaging effect of relief, and the differential interference microscope is also typically used to achieve the imaging effect of relief. In addition, the Hoffman phase contrast microscope and the differential interference microscope have requirements for an observed sample. For example, the Hoffman microscope is prone to bright and dark background streaks when used to photograph a thicker sample, while the differential interference microscope has a requirement for a birefringent optical path, which means that a sample may not contain materials sensitive to polarization. All of these constraints limit the application scope of microscopes.

In some embodiments, a 4f system loaded with a spiral phase plate has been extensively studied to overcome the limited imaging effect of traditional microscopes. However, the 4f system requires to use a pair of lenses to perform a Fourier transform and an inverse Fourier transform on an object light during the imaging process, and an additional introduced lens results in a decrease in an imaging resolution and an increase in an optical aberration. Compared to microscopes, the imaging quality of the 4f system is lower.

Therefore, how to enrich the imaging effect of the phase contrast microscope while ensuring the imaging quality of the phase contrast microscope and minimizing the modification to an original optical path has become a problem to be solved.

The present disclosure provides an imaging system, an objective lens module, and a combination of elements, in which the phase modulation unit is located in a plane conjugate to a plane containing the light source, thereby avoiding introducing an additional lens performing a Fourier transform, and enrich the imaging effect of the phase contrast microscope while ensuring the imaging quality of the phase contrast microscope.

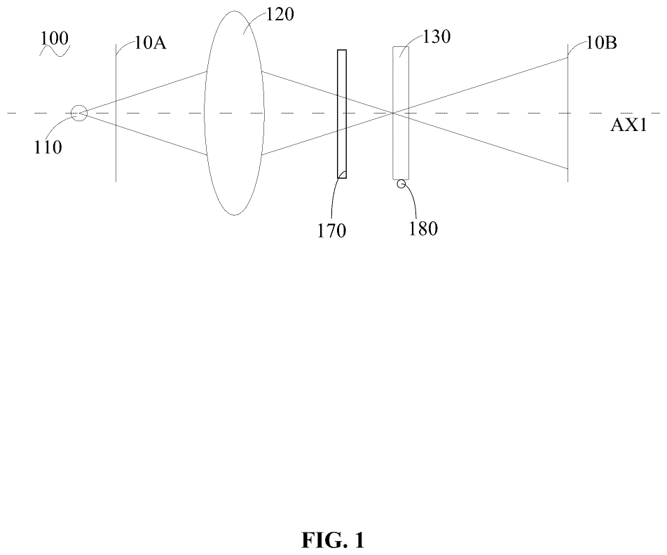

FIG. 1 is a schematic diagram illustrating an imaging optical path according to some embodiments of the present disclosure.

Some embodiments of the present disclosure provide an imaging system 100.

In some embodiments, as shown in FIG. 1, the imaging system 100, arranged along an optical axis AX1 from an object side to an image side, includes: a light source 110, configured to provide light for illuminating a sample; an imaging lens group 120, configured to receive the light exiting from the sample and perform at least one imaging for the sample; and a phase modulation unit 130, configured to modulate the light exiting from the imaging lens group 120 and obtain a desired sample image at an imaging plane 10B of the imaging system.

The light source refers to an optical element for providing the light to illuminate the sample. Merely by way of example, the light source may include a parallel light source and a point light source, and may further include a line light source or an area light source that may be equated to the point light source.

The sample refers to an object to be observed. Merely by way of example, the sample may include a transparent or a low-contrast object (e.g., biological cells, unstained tissues, polymer films, etc.), etc.

The imaging lens group refers to a group of lenses that refract the light for imaging. Merely by way of example, the imaging lens group includes at least one converging lens. Merely by way of example, the imaging lens group as a whole converges the light, or the imaging lens group as a whole has a positive focal power.

Merely by way of example, when the light source 110 is a parallel light source, a plane containing the phase modulation unit 130 coincides with a back focal plane of the imaging lens group 120.

During the imaging, the sample is disposed between the light source 110 and the imaging lens group 120, a position of the sample is shown by an object plane 10A; the light source 110 illuminates the sample to form light carrying sample information; and the light carrying the sample information reaches the imaging plane 10B of the imaging system 100 ultimately after exiting from the imaging lens group 120 and the phase modulation unit 130 sequentially along the optical axis AX1.

In some embodiments, the plane containing the phase modulation unit 130 and a plane containing the light source 110 form a pair of conjugate planes; and, at least an optical path between the plane containing the phase modulation unit 130 and the imaging plane 10B of the imaging system 100 introduces no lens or lens group performing a Fourier transform.

Merely by way of example, when an object is imaged through an optical system, an object point and an image point correspond to each other one-to-one, the object point and the image point are a pair of conjugate points, and a plane containing the object point and a plane containing the image point are a pair of conjugate planes. Taking the light source 110 as the object point, an image formed by the light source 110 through the imaging lens group 120 is an image point of the light source 110, and when the image point of the light source 110 is located in the plane containing the phase modulation unit 130, the plane containing the phase modulation unit 130 and the plane containing the light source 110 are a pair of conjugate planes.

In some embodiments, an optical path between a plane containing the phase modulation unit and an imaging plane of an imaging system introduces no lens or lens group performing a Fourier transform, which may be understood as follows: there is no lens or a lens group provided in the optical path; and which may also be understood as follows: although a lens or lens group is provided in the optical path, neither lens of the lens nor lens group performs the Fourier transform on the light, or the lens group as a whole does not perform the Fourier transform on the light. It is understood that there is an accurate Fourier transform relationship between a front focal plane and a back focal plane of the lens (or the lens group as a whole). Therefore, the back focal plane of the lens (or the lens group as a whole) may be referred to as a Fourier transform plane of the optical path, and an effective Fourier transform is performed by the lens or the lens group in the optical path when the back focal plane of the lens (or the lens group as a whole) coincides with the imaging plane.

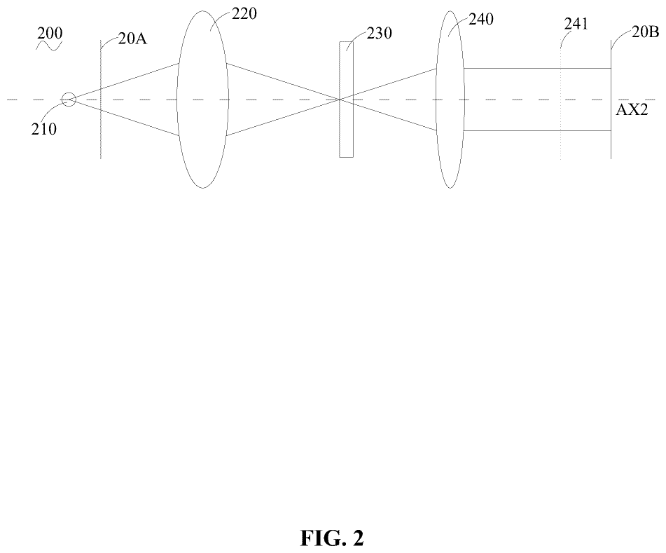

FIG. 2 is another schematic diagram illustrating an imaging optical path according to some embodiments of the present disclosure.

The following illustrations are further described in conjunction with the diagrams of imaging optical paths of the imaging system 100 and an imaging system 200. More descriptions regarding the imaging system 200 may be found in the related descriptions below.

Merely by way of example, as shown in FIG. 1, the phase modulation unit 130 is adjacent to the imaging plane 10B, i.e., no additional optical elements arae provided between the phase modulation unit 130 and the imaging plane 10B, and the optical path between the phase modulation unit 130 and the imaging plane 10B introduces no lens or lens group performing a Fourier transform.

Merely by way of example, as shown in FIG. 2, although an intermediate lens group 240 is provided between a phase modulation unit 230 and an imaging plane 20B, a back focal plane 241 (i.e., the Fourier transform plane) of the intermediate lens group 240 deviates from the imaging plane 20B.

The above imaging system is conducive to achieving more diverse imaging effects (e.g., edge enhancement and relief imaging) compared with observing in the bright field (i.e. a micrograph of a planar visual effect), by introducing the phase modulation unit in the imaging optical path and enabling the plane containing the phase modulation unit and the plane containing the light source to form a pair of conjugate planes. In addition, since at least the optical path between the plane containing the phase modulation unit and the imaging plane of the imaging system introduces no lens or lens group performing a Fourier transform, a decrease in the imaging resolution can be avoided and the imaging quality can be improved.

Taking the imaging process of the imaging system 100 as an example, the principle whereby imaging system 100 achieves enhanced phase contrast microscopic imaging while ensuring the imaging quality of the phase contrast microscope is as follows:

In some embodiments, a light field distribution of a spherical wave emitted by the light source 110 (e.g., a point light source) transmitting to the object plane 10A in a near-axis approximation may be expressed by an equation (1):

$${E}_{0} ( {x}_{0} , {y}_{0} ) = α \cdot exp [ \frac{ik}{2 R} ( {x}_{0}^{2} + {y}_{0}^{2} ) ] A ( {x}_{0} , {y}_{0} ) \qquad ( 1 )$$

In the equation (1), E₀(x₀, y₀) denotes the light field distribution of the spherical wave emitted by the light source 110 transmitting to the object plane 10A, R denotes a distance from the light source 110 to the object plane 10A on the optical axis AX1, x₀ and y₀ denote spatial coordinates on the object plane 10A, A(x₀, y₀) denotes a sample transmission function, i denotes an imaginary unit, k denotes a count of spherical waves, a denotes a constant that does not affect the light field distribution, and exp denotes an exponential function with e as a base.

A light field distribution E₁(x₁, y₁) immediately in front of the imaging lens group 120 may be obtained according to a Fresnel diffraction equation, and then after the imaging lens group 120 is focused, a light field distribution E₂(x₂, y₂) of an object wave (i.e., the spherical wave carrying object information) transmitting to the plane containing the phase modulation unit 130 may be obtained, and a light field distribution of the object wave on the imaging plane 10B may be obtained after filtering, which may be expressed by an equation (2):

$${E}_{3} ( {x}_{3} , {y}_{3} ) = γ exp ( ik \frac{{x}_{3}^{2} + {y}_{3}^{2}}{2 {d}_{2}} ) F \{ H ( {x}_{2} , {y}_{2} ) \cdot F [ β \cdot A ( {x}_{0} , {y}_{0} ) ] \vert u = \frac{{Rx}_{2}}{λ {d}_{1} Δ} , v = \frac{{Ry}_{2}}{λ {d}_{1} Δ} \} \vert u = \frac{{x}_{3}}{λ {d}_{2}} , v = \frac{{y}_{3}}{λ {d}_{2}} \qquad ( 2 )$$

In the equation (2), E₃(x₃, y₃) denotes the light field distribution of the object light wave in the imaging plane after filtering, x₂ and y₂ denote spatial coordinates on the plane containing the phase modulation unit 130, x₃ and y₃ denote spatial coordinates on the imaging plane 10B, γ and β are constants, d₁ denotes a distance between the plane containing the phase modulation unit 130 and the imaging lens group 120 on the optical axis AX1, d₂ denotes a distance between the plane containing the phase modulation unit 130 and the imaging plane 10B on the optical axis AX1, f denotes a focal length of the imaging lens group 120, F denotes a Fourier transform, u and v denote spectral coordinates of the Fourier transform, H(x₂, y₂) denotes a transmission function of the phase modulation unit 130, and 2 denotes a wavelength.

It can be seen that E₃(X₃, y₃) has basically the same as the expression of the final light field function of the 4f system for achieving phase contrast imaging, except for an additional quadratic phase factor which does not affect a light field intensity distribution. Thus, the structural setup of the embodiments of the present disclosure can achieve a phase contrast imaging effect that is substantially the same as the phase contrast imaging effect of the 4f system without additionally introducing lens performing a Fourier transform, and at the same time, the reduction in the introduction of the lens is conductive to reduce the optical aberration and improve the imaging resolution.

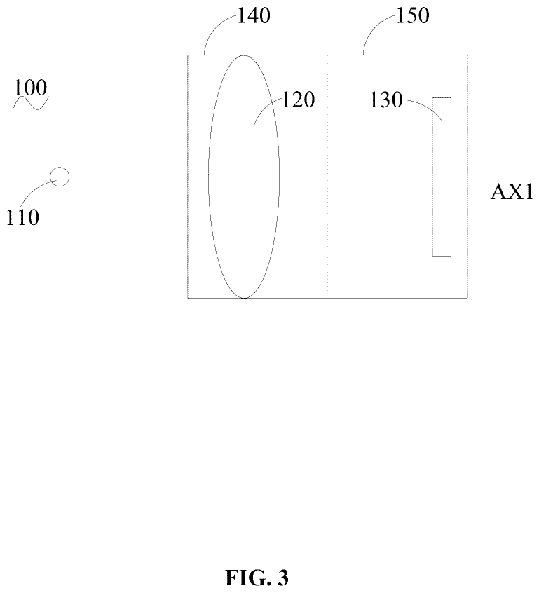

FIG. 3 is a schematic diagram illustrating a structure of a first housing and a second housing according to some embodiments of the present disclosure.

In some embodiments, as shown in FIG. 3, the imaging system 100 further includes: a first housing 140 configured to accommodate the imaging lens group 120; and a second housing 150 configured to accommodate the phase modulation unit 130. The first housing 140 and the second housing 150 are integrally formed or detachably connected.

The first housing 140 is configured to fix the imaging lens group 120, and the second housing 150 is configured to fix the phase modulation unit 130. In some embodiments, when the first housing 140 and the second housing 150 are integrally formed, the imaging lens group 120 and the phase modulation unit 130 may be disposed in a same lens barrel (e.g. the imaging lens group 120 and the phase modulation unit 130 may be disposed together in an objective lens), which is conductive to the modularity of the imaging system 100 (e.g., the objective lens may directly replace an original objective lens when needed). In some embodiments, the first housing 140 and the second housing 150 may be detachably connected by a threaded connection, a magnetic connection, or a snap connection, etc. When the first housing 140 and the second housing 150 are detachably connected, the imaging lens group 120 and the phase modulation unit 130 are fixed to different housings, for example, the imaging lens group 120 is a lens group in the objective lens, and a housing containing the phase modulation unit 130 serves as an external module.

The housing containing the phase modulation unit is assembled to the objective lens to enable the plane containing the phase modulation unit conjugate to the plane containing the light source, which can form the imaging system by assembling the external module without modifying the structure of the objective lens, so as to reduce the preparation cost.

In some embodiments, the phase modulation unit 130 includes a spiral phase plate. Different phase contrast imaging effects can be obtained by controlling a relative positional relationship between an image of the light source 110 in the plane containing the spiral phase plate and a center of the spiral phase plate.

Merely by way of example, a transmission function of the spiral phase plate may be expressed by an equation (3):

$$H ( r , θ ) = circ ( \frac{r}{{R}_{spp}} ) exp ( il θ ) , \qquad ( 3 )$$

In the equation (3), H(r, θ) denotes the transmission function of the spiral phase plate, circ denotes an aperture function, exp denotes an exponential function with e as a base, r denotes a radial coordinate, θ denotes an angular coordinate, l denotes an arbitrary integer, and Rₛₚₚ denotes a radius of the spiral phase plate.

Merely by way of example, when the image of the light source 110 on the plane containing the phase modulation unit 130 coincides with the center of the phase modulation unit 130, a phase contrast micrograph with edge enhancement may be obtained; when the image of the light source 110 on the plane containing the phase modulation unit 130 deviates from the center of the phase modulation unit 130 and the center of the phase modulation unit 130 is still located on the plane containing the phase modulation unit 130, a phase contrast micrograph with a relief effect may be obtained.

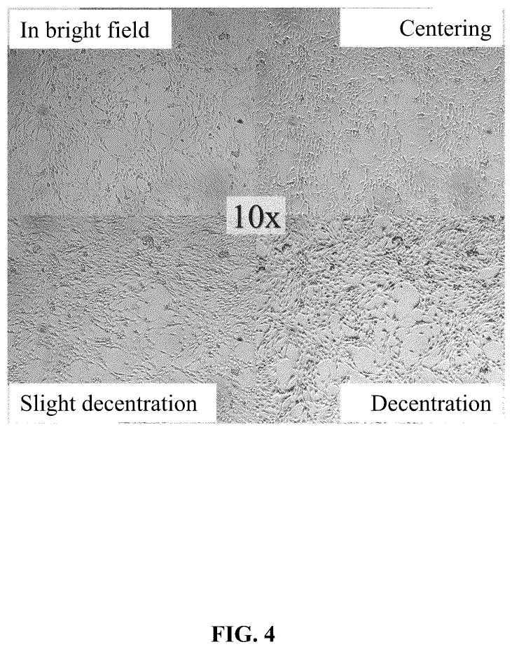

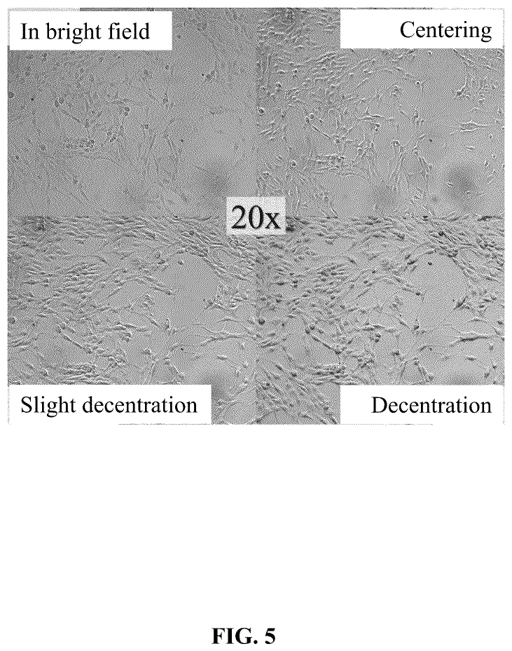

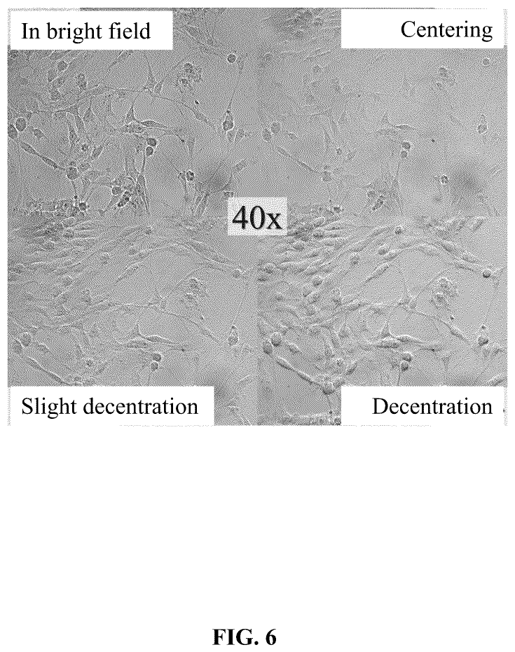

FIG. 4 is a schematic diagram illustrating a comparison of phase-contrast micrographs at tenfold magnification according to some embodiments of the present disclosure; FIG. 5 is a schematic diagram illustrating a comparison of phase-contrast micrographs at twentyfold magnification according to some embodiments of the present disclosure; FIG. 6 is a schematic diagram illustrating a comparison of phase-contrast micrographs at fortyfold magnification according to some embodiments of the present disclosure.

Merely by way of example, as shown in FIGS. 4, 5, and 6, when an image is observed in a bright field, detailed textures of a transparent sample is not obvious at different magnifications; when an image of the light source (i.e., an image of the light source on the plane containing the spiral phase plate) coincides with a center of the spiral phase plate (i.e., centering), the details of an edge of the transparent sample are enhanced; when the image of the light source slightly deviates from the center of the spiral phase plate, the details of the transparent sample appear a bright and dark distribution, and a three-dimensional relief imaging effect is revealed; and when the image of the light source deviates from the center of the spiral phase plate, details of the transparent sample exhibit an obvious relief imaging effect.

Merely by way of example, some embodiments of adjusting a relative positional relationship between the image of the light source on the plane containing the phase modulation unit and the center of the phase modulation unit are described below.

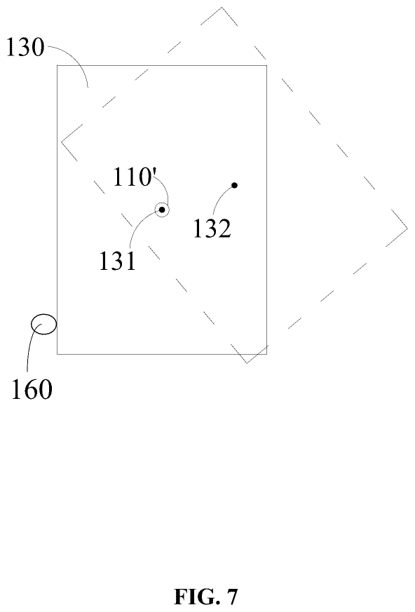

FIG. 7 is a schematic diagram illustrating a structure of adjusting a phase modulation unit for centering and decentration according to some embodiments of the present disclosure.

In some embodiments, as shown in FIG. 7, when a position of an image 110′ of the light source 110 on the plane containing the phase modulation unit 130 (e.g., a spiral phase plate) is fixed, a position of the phase modulation unit 130 may be adjusted to enable a center of the phase modulation unit 130 (e.g., a black solid circle shown in FIG. 7) to move between a first position 131 and a second position 132 to achieve coincidence or deviation between the phase modulation unit 130 and the light source imaging 110′.

In some embodiments, as shown in FIG. 7, the imaging system 100 further includes a first adjustment mechanism 160 connected to the phase modulation unit 130; wherein the first adjustment mechanism 160 is configured to adjust the position of the phase modulation unit 130 within the plane containing the phase modulation unit 130 based on user operation, enabling the center of the phase modulation unit 130 to coincide with or deviate from the image of the light source 110 on the plane containing the phase modulation unit 130.

The first adjustment mechanism 160 is configured to adjust a position of the phase modulation unit 130 in a two-dimensional plane. For example, the first adjustment mechanism 160 may enable the phase modulation unit 130 to translate or rotate within the plane containing the phase modulation unit 130. For example, the first adjustment mechanism 160 may be a manual adjustment structure (e.g., a threaded hole may be provided on a housing for fixing the phase modulation unit, and an adjustment may be made by a combination of a screw and the threaded hole) or an electrical adjustment mechanism (e.g., an adjustment may be made by driving a drive motor).

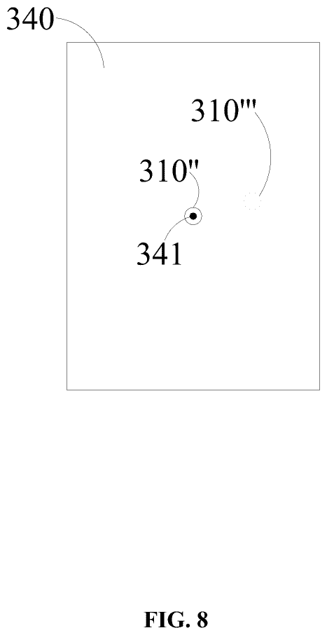

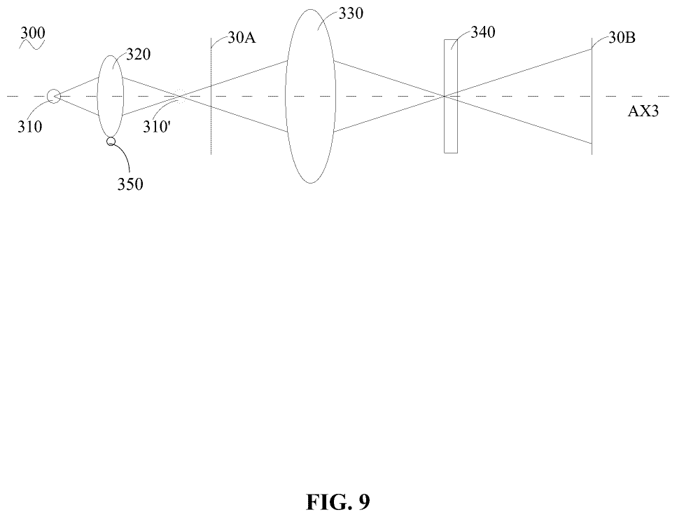

FIG. 8 is a schematic diagram illustrating a structure of adjusting a front lens for centering and decentration according to some embodiments of the present disclosure. FIG. 9 is another schematic diagram illustrating an imaging optical path according to some embodiments of the present disclosure.

In other embodiments, as shown in FIG. 8, when a center 341 of a phase modulation unit 340 (e.g., a spiral phase plate) is fixed, an image of a light source 310 on a plane containing the phase modulation unit 340 may be made to move to achieve an image 310″ of the light source coinciding with or deviating from the center of the phase modulation unit 340.

As shown in FIG. 9, an imaging system 300 in some embodiments of the present disclosure, arranged along an optical axis AX3 from an object side to an image side, includes: a light source 310, configured to provide light for illuminating a sample; an imaging lens group 330, configured to receive the light exiting from the sample and perform at least one imaging for the sample; and a phase modulation unit 340, configured to modulate the light exiting from the imaging lens group 330, and obtain a desired sample image at an imaging plane 30B of the imaging system 300.

In some embodiments, as shown in FIG. 9, the imaging system 300 further includes a front lens 320 arranged between the light source 310 and the imaging lens group 330 and configured to converge the light exiting from the front lens 320; and a second adjustment mechanism 350 connected to the front lens 320; wherein the second adjustment mechanism 350 is configured to adjust a position of the front lens 320 based on user operation, enabling an image of a convergence point 310′ formed by the light emitted from the light source 310 imaging on the plane containing the phase modulation unit 340 (e.g., a spiral phase plate) after passing through the front lens 320 to coincide with or deviate from the center of the phase modulation unit 340.

During the imaging, the sample is disposed between the front lens 320 and the imaging lens group 330, a position of the sample is shown by an object plane 30A; the light emitted from the light source 310 is converged by the front lens 320 to form the convergence point 310′ between the front lens 320 and the sample; the light pass through the convergence point 310′ illuminates the sample to form light carrying sample information; and the light carrying the sample information reach the imaging plane 30B of the imaging system 300 ultimately after exiting from the front lens 320 and the phase modulation unit 340 sequentially along the optical axis AX3.

In some embodiments, in conjunction with FIG. 8 and FIG. 9, when the second adjustment mechanism 350 controls the front lens 320 to be in a third position, a first image 310″ of the convergence point 310′ of the light source 310 coincides with the center of the phase modulation unit 340, and when the second adjustment mechanism 350 controls the front lens 320 to be in a fourth position, a second image 310″ of the convergence point 310′ of the light source 310 (i.e., an image of the convergence point 310′ of the light source 310 after a position of the front lens 320 is adjusted) deviates from the center of the phase modulation unit 340. Merely by way of example, the second adjustment mechanism may be a manual adjustment structure (e.g. an adjustment may be made by a screw or gear transmission) and an electrical adjustment mechanism (e.g. an adjustment may be made by driving a drive motor).

The third position refers to a position of the front lens 320 when the first image 310″ of the convergence point 310′ of the light source 310 coincides with the center of the phase modulation unit 340. The fourth position refers to a position of the front lens 320 when the second imaging 310″ of the convergence point 310′ of the light source 310 deviates from the center of the phase modulation unit 340.

In some embodiments, a position of the phase modulation unit and a position of the front lens may be adjusted synchronously. For example, the imaging system is provided with both the first adjustment mechanism and the second adjustment mechanism to achieve an image of the light source (or a convergence point of the light source) to coincide with or deviate from the center of the phase modulation unit more easily.

In some embodiments, as shown in FIG. 1, the imaging system 100 may further include a filter 170 arranged between the front lens 120 and the imaging lens group 130 and configured to filter the light exiting from the front lens 120 before the light illuminates the sample.

The filter 170 may filter out influence of ambient stray light on the image to improve the imaging quality.

In some embodiments, the imaging system 100 further includes a carrier stage for carrying the sample, so that when the sample is thin, a distance from the object plane 10A of the imaging system 100 to the imaging lens group 120 may be expressed as a distance from the carrier stage to the imaging lens group 120 along the optical axis AX1; when the sample is thicker, the distance from the object plane 10A of the imaging system 100 to the imaging lens group 120 need to consider a thickness of the sample, and the distance from the object plane 10A of the imaging system 100 may be expressed as a distance from the carrier stage to the imaging lens group 120 along the optical axis AX1 minus the thickness of the sample.

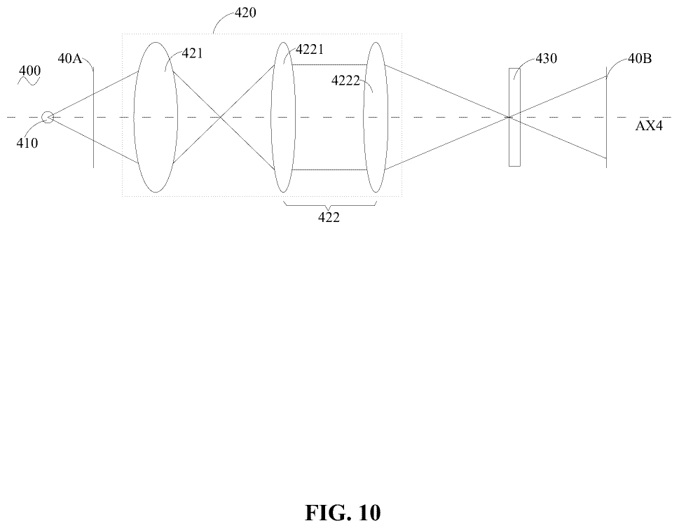

FIG. 10 is a schematic diagram illustrating an imaging optical path according to some embodiments of the present disclosure.

In some embodiments, as shown in FIG. 10, an imaging system 400, arranged along an optical axis AX4 from an object side to an image side, includes: a light source 410, configured to provide light for illuminating a sample; an imaging lens group 420, configured to receive the light exiting from the sample and perform at least one imaging for the sample; and a phase modulation unit 430, configured to modulate the light exiting from the imaging lens group 420, and obtain a desired sample image at an imaging plane 40B of the imaging system 400.

In some embodiments, as shown in FIG. 10, the imaging lens group 420, arranged along the optical axis AX4 from the object side to the image side, includes: at least one imaging lens 421; and at least one relay lens 422; wherein light carrying sample information reaches the phase modulation unit 430 after exiting from the at least one imaging lens 421 and the at least one relay lens 422 sequentially.

The imaging lens is used to converge the light to form an initial image. The relay lens is used to optimize the imaging quality. Merely by way of example, the at least one relay lens 422 includes a first relay lens 4221 and a second relay lens 4222.

During the imaging, the sample is disposed between the light source 410 and the imaging lens 421, a position of the sample shown by an object plane 40A; the light source 410 illuminates the sample to form the light carrying the sample information; and the light carrying the sample information reaches the imaging plane 40B of the imaging system 400 ultimately after exiting from the imaging lens 421, the first relay lens 4221, the second relay lens 4222, and the phase modulation unit 430 sequentially along the optical axis AX4.

Setting the at least one relay lens is conductive to accurately positioning and better focusing the sample, thereby improving the imaging clarity. In this way, it is also conductive to obtaining an objective lens module suitable for an inverted microscope, thus convenient for the user to observe cultured live cells.

In some embodiments, with continued reference to FIG. 1, the plane containing the phase modulation unit 130 coincides with the back focal plane of the imaging lens group 120.

There are two main reasons for the arrangement. Firstly, in an original imaging optical path, a parallel light source is mostly used for illuminating the sample, and at the time, the plane containing the phase modulation unit 130 (i.e., the plane conjugate to the plane containing the light source 110) and the back focal plane of the imaging lens group 120 are unified. Secondly, the position where the phase modulation unit 130 is located along the direction of the optical axis AX1 has a certain tolerance degree, which is basically located between the back focal plane of the imaging lens group 120 and the plane conjugate to the plane containing the light source 110. In summary, the back focal plane of the imaging lens group 120 is adopted as the position of the phase modulation unit 130, which can not only ensure the desired imaging effect and facilitate the preparation of the imaging system 100, but also the setup applicable to most microscopes, thereby conductive to achieving industrialization.

In some embodiments, with continued reference to FIG. 1, the imaging system 100 further includes a third adjustment mechanism 180 connected to the phase modulation unit 130 and configured to adjust a position of the phase modulation unit 130 along the optical axis AX1 based on user operation.

There are three reasons for providing a third adjustment mechanism. Firstly, an illuminating form that can be adapted to the point light source is convenient for the plane containing the phase modulation unit 130 to match a plane containing an image of the point light source. Secondly, a position of the back focal plane of the imaging lens group 120 at different magnifications is usually different, and it is convenient to match the plane containing the phase modulation unit 130 with the back focal plane of the imaging lens group 120 at different magnifications by providing the third adjustment mechanism. Thirdly, when the position of the phase modulation unit 130 is shifted, the position of the phase modulation unit 130 may be calibrated by the third adjustment mechanism.

Merely by way of example, the third adjustment mechanism may be a manual adjustment structure (e.g., an adjustment may be made by a screw or gear transmission) and an electrical adjustment mechanism (e.g., an adjustment may be made by driving a drive motor).

In some embodiments, the imaging system 100 has a target plane conjugate to the plane containing the light source 110, the plane containing the phase modulation unit 130 is arranged between the back focal plane of the imaging lens group 120 and the target plane; and, at least the optical path between the plane containing the phase modulation unit 130 and the imaging plane of the imaging system 100 introduces no lens or lens group performing a Fourier transform. More descriptions regarding the light source 110, the imaging lens group 120, and the phase modulation unit 130 may be found in related descriptions above.

Taking into account that the position where the phase modulation unit 130 is located along the direction of light propagation has a certain tolerance degree, the phase modulation unit can be positioned basically between the back focal plane of the imaging lens group and the target plane, so that the above imaging system can still achieve more diverse imaging effects compared with observing in the bright field. In addition, at least the optical path between the plane containing the phase modulation unit and the imaging plane of the imaging system introduces no lens or lens group performing a Fourier transform, which may avoid a decrease in the imaging resolution and improve the imaging quality.

In some embodiments, as shown in FIG. 1, the plane containing the phase modulation unit 130 and the plane containing the light source 110 of the imaging system 100 form a pair of conjugate planes; and, the plane containing the phase modulation unit 130 is adjacent to the imaging plane 10B of the imaging system 100. More descriptions regarding the portion may be found in the related descriptions in FIG. 1.

The above imaging system 100 is conductive to achieving more diverse imaging effects compared to observing in the bright field by introducing the phase modulation unit 130 in the imaging optical path and enabling the plane containing the phase modulation unit 130 and the plane containing the light source 110 to form a pair of conjugate planes. In addition, at least the optical path between the plane containing the phase modulation unit 130 and the imaging plane 10B of the imaging system 100 introduces no lens or lens group performing a Fourier transform, which may avoid a decrease in the imaging resolution and improve the imaging quality.

In some embodiments, as shown in FIG. 2, the imaging system 200, arranged along an optical axis AX2 from an object side to an image side, includes: a light source 210, configured to provide light for illuminating a sample; an imaging lens group 220, configured to receive the light exiting from the sample and perform at least one imaging for the sample; and the phase modulation unit 230, configured to modulate the light exiting from the imaging lens group 220, and obtain a desired sample image at the imaging plane 20B of the imaging system 200.

In some embodiments, as shown in FIG. 2, a plane containing the phase modulation unit 230 and a plane containing the light source 210 of the imaging system 200 form a pair of conjugate planes; and, the intermediate lens group 240 is arranged between the plane containing the phase modulation unit 230 and the imaging plane 20B of the imaging system 200, and the back focal plane 241 of the intermediate lens group 240 deviates from the imaging plane 20B.

During the imaging, the sample is disposed between the light source 210 and the imaging lens group 220, a position of the sample is shown by an object plane 20A; the light source 210 illuminates the sample to form light carrying sample information; the light carrying the sample information reaches the imaging plane 20B of the imaging system 200 ultimately after emitting from the imaging lens group 220, the phase modulation unit 230, and the intermediate lens group 240 sequentially along the optical axis AX2.

The above imaging system 200 is conducive to achieving more diverse imaging effects compared with observing in the bright field by introducing the phase modulation unit 230 in the imaging optical path and enabling the plane containing the phase modulation unit 230 and the plane containing the light source 210 to form a pair of conjugate planes. In addition, at least the optical path between the plane containing the phase modulation unit 230 and the imaging plane 20B of the imaging system 200 introduces no lens or lens group performing a Fourier transform, which may avoid a decrease in the imaging resolution and improve the imaging quality.

Some embodiments of the present disclosure provide a preparation method for an imaging system (hereinafter referred to as a preparation method).

In some embodiments, the preparation method includes the following operations.

In S100, a light source, an imaging lens group, and a phase modulation unit are provided;

In S200, the light source, the imaging lens group, and the phase modulation unit are arranged sequentially along an optical axis of the imaging lens group;

In S300, a position of the phase modulation unit is adjusted to enable a plane containing the phase modulation unit and a plane containing the light source to form a pair of conjugate planes; wherein at least the optical path between the plane containing the phase modulation unit and the imaging plane of the imaging system introduces no lens or lens group performing a Fourier transform.

The above preparation method of the imaging system is conducive to obtaining the imaging system for achieving more diverse imaging effects by sequentially arranging the light source, the imaging lens group, and the phase modulation unit and adjusting the phase modulation unit to the plane conjugate to the plane containing the light source.

In some embodiments, a plane containing an adjusted phase modulation unit coincides with a back focal plane of the imaging lens group. In this way, the desired imaging effect is ensured and the preparation of the imaging system is facilitated.

Some embodiments of the present disclosure provide an image acquisition device.

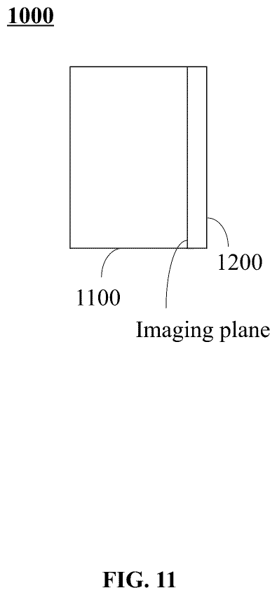

FIG. 11 is a schematic diagram illustrating a structure of an image acquisition device according to some embodiments of the present disclosure.

In some embodiments, as shown in FIG. 11, an image acquisition device 1000 includes an imaging system 1100 and a photosensitive element 1200, wherein a photosensitive surface of the photosensitive element 1200 coincides with an imaging plane of the imaging system 1100. The imaging system 1100 may be any imaging system described in any of the previous embodiments.

The photosensitive element is configured to convert an optical signal into an electrical signal. Merely by way of example, the photosensitive element may adopt at least one of a complementary metal oxide semiconductor (CMOS) image sensor, a charge-coupled device (CCD) image sensor, etc.

The above image acquisition device can photograph to obtain the phase contrast micrograph with different imaging effect and high imaging quality by adjusting the relative positional relationship between the phase modulation unit and the light source imaging.

Some embodiments of the present disclosure further provide an objective lens module. The objective lens module works with an eyepiece to facilitate a user to observe a transparent sample, or works with a camera to facilitate to take an image of the transparent sample after imaging.

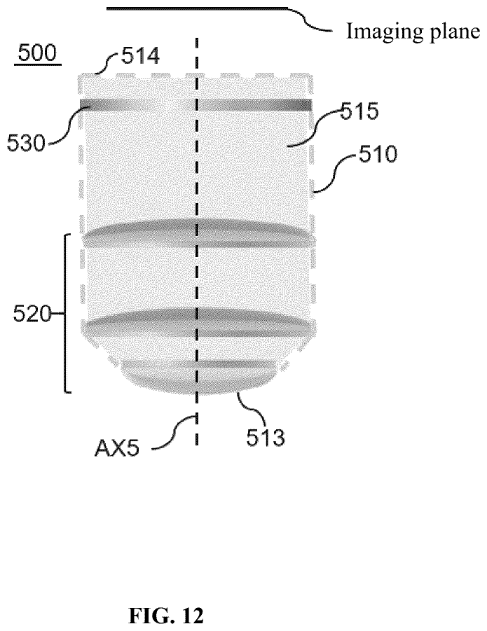

FIG. 12 is a schematic diagram illustrating an objective lens module according to some embodiments of the present disclosure.

In some embodiments, as shown in FIG. 12, the objective lens module 500 includes: a housing 510; an imaging lens group 520, arranged within the housing 510 and configured to receive light emitted by a light source and light exiting from a sample and perform at least one imaging for the sample; a phase modulation unit 530, arranged within the housing 510 and configured to modulate the light exiting from the imaging lens group 520 and obtain a desired sample image at an imaging plane of the objective lens module 500; wherein a plane containing the phase modulation unit 530 and a plane containing the light source form a pair of conjugate planes, and at least an optical path between the plane containing the phase modulation unit and an imaging plane of the imaging system introduces no lens or lens group performing a Fourier transform. More descriptions regarding the imaging lens group may be found in the related descriptions in FIG. 1.

During the imaging period, the sample is disposed between the light source and the imaging lens group 520, the light source provides the light for illuminating the sample to form light carrying sample information after exiting from the sample, and the light carrying the sample information reaches the imaging plane of the objective lens module 500 ultimately after exiting from the imaging lens group 520 and the phase modulation unit 530 sequentially.

The understanding of “conjugate” and “an optical path between the plane containing the phase modulation unit 530 and an imaging plane of the external imaging module 800 introduces no lens or lens group performing a Fourier transform” is similar to that described above, which may be found in the embodiments above.

The above objective lens module 500 can achieve more imaging effects without modifying the original imaging optical path by introducing the phase modulation unit 530 in the imaging optical path and enabling the plane containing the phase modulation unit 530 and the plane containing the light source to from a pair of conjugate planes. In addition, at least the optical path between the plane containing the phase modulation unit 530 and the imaging plane of the objective lens module 500 introduces no lens or lens group performing a Fourier transform, which may avoid a decrease in the imaging resolution and improve the imaging quality.

In some embodiments, with continued reference to FIG. 12, the housing 510 includes an entrance end 513 of the light, an exit end 514 of the light, and an optical aperture 515 penetrating through both the entrance end 513 of the light and the exit end 514 of the light along an optical axis AX5 of the objective lens module 500; wherein the imaging lens group 520 and the phase modulation unit 530 are connected to a wall of the optical aperture 515.

By the above method, the phase modulation unit 530 can be integrated into the original objective lens to obtain a dedicated spiral phase contrast objective lens, and when the user observes the transparent sample, the spiral phase contrast objective lens can be used directly to replace the ordinary objective lens on the microscope to achieve effective observation of the transparent sample.

In some embodiments, the imaging lens group 520, arranged along the optical axis AX5 from an object side to an image side, includes: at least one imaging lens; and at least one relay lens; wherein light carrying the sample information reaches the phase modulation unit 530 after exiting from the at least one imaging lens and the at least one relay lens sequentially.

Setting the at least one relay lens is conductive to accurately positioning and better focus the sample, thereby improving the imaging clarity; at the same time, it is not necessary to limit to the scheme of installing a phase modulation unit to the original objective lens, and it is possible to search for a position of a plane conjugate to the plane containing the light source in the imaging optical path expanded by the relay lens to set up the phase modulation unit, i.e., there is a freer space to choose to place the phase modulation unit, so as to obtain the objective lens module of the present disclosure. The objective lens module obtained by the embodiment of the present disclosure can be applied to an inverted microscope, thereby convenient for the user to observe cultured live cells.

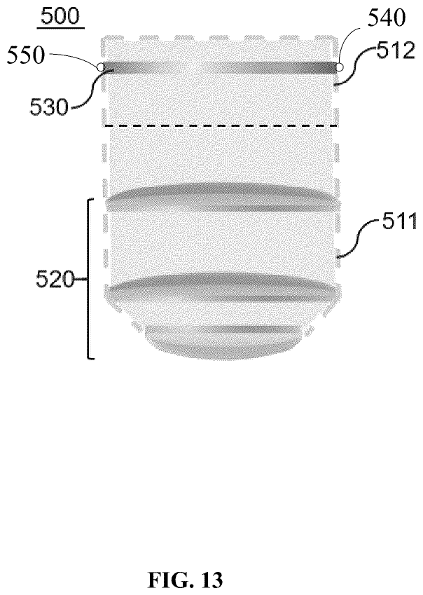

FIG. 13 is another schematic diagram illustrating an objective lens module according to some embodiments of the present disclosure.

In some embodiments, as shown in FIG. 13, the housing 510 includes a first housing 511 and a second housing 512 that are detachably connected; wherein the imaging lens group 520 is arranged within the first housing 511, and the phase modulation unit 530 is arranged within the second housing 512.

In this way, the objective lens module 500 can be divided into at least two independent modules, thereby facilitating cleaning, and when one of the at least two independent modules is damaged, only the damaged module needs to be replaced without replacing all of the modules, thereby reducing the maintenance cost. In addition, in the embodiment, the lens in an ordinary objective lens can be used as the imaging lens group 520, i.e., there is no need to change the original objective lens (in other words, it is applicable to any original objective lens), and the imaging effect basically consistent with that of the spiral phase contrast objective lens can be achieved by connecting an external module equipped with the phase modulation unit 530, thereby eliminating the need to additionally purchase a spiral phase contrast objective lens or a mid-range or high-end phase contrast microscope, and greatly reducing the cost.

In some embodiments, as shown in FIG. 12, the plane containing the phase modulation unit 530 coincides with a back focal plane of the imaging lens group 520.

There are two main reasons for such a setup. Firstly, in an original imaging optical path, a parallel light source is mostly used for illuminating the sample, and at the time, the plane containing the phase modulation unit 530 (i.e., a plane conjugate to the plane containing the light source) and the back focal plane of the imaging lens group 520 are unified. Secondly, the position where the phase modulation unit 530 is located along the direction of the optical axis AX5 has a certain tolerance degree, which is basically located between the back focal plane of the imaging lens group 520 and the plane conjugate to the plane containing the light source. In summary, in the objective lens module 500, the back focal plane of the imaging lens group 520 is adopted as the position of the phase modulation unit 130, which can not only ensure the desired imaging effect and facilitate the preparation of the imaging system 100, but also the setup applicable to most microscopes, thereby conductive to achieving industrialization.

In some embodiments, the phase modulation unit 530 includes a spiral phase plate.

In some embodiments, when an image of the light source on the plane containing the phase modulation unit 530 coincides with a center of the phase modulation unit 530, a phase contrast micrograph with edge enhancement may be obtained; when the image of the light source on the plane containing the phase modulation unit 530 deviates from the center of the phase modulation unit 530 and the center of the phase modulation unit 530 is still located on the plane containing the phase modulation unit 530, a phase contrast micrograph with a relief effect may be obtained.

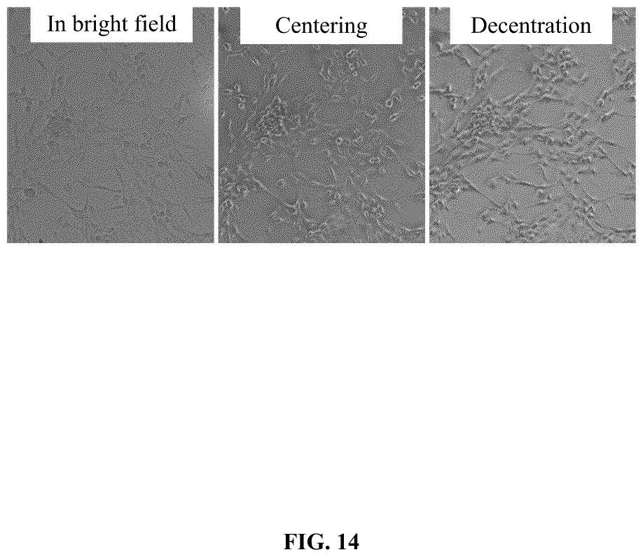

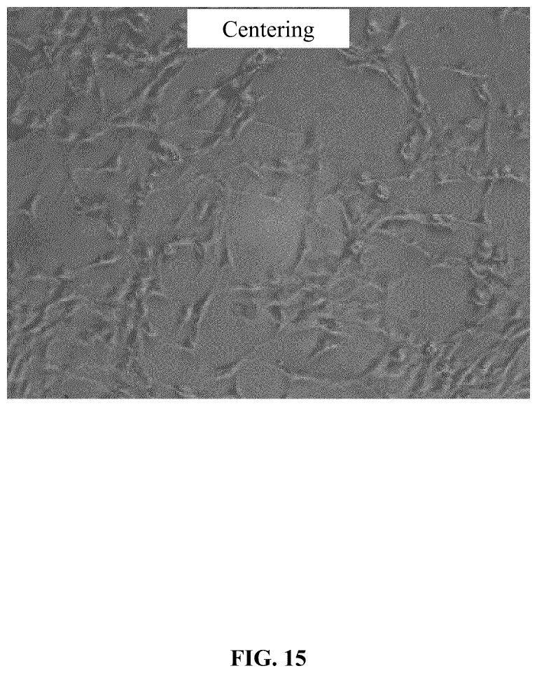

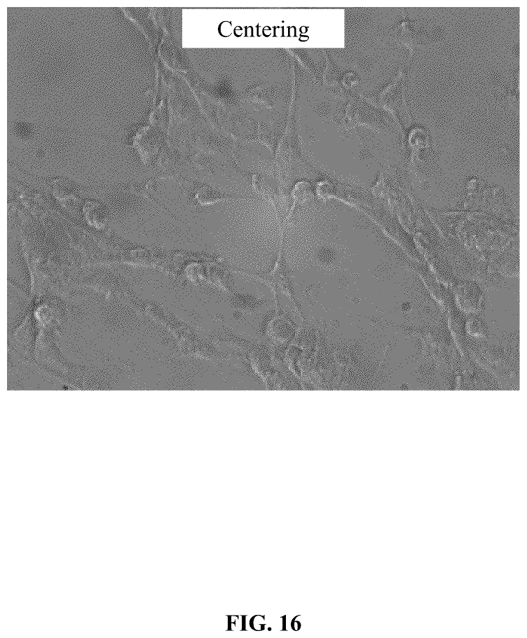

FIG. 14 is a schematic diagram illustrating a comparison of a tumor cell sample observed by an objective lens module at tenfold magnification according to some embodiments of the present disclosure; FIG. 15 is a schematic diagram illustrating an image of a tumor cell sample observed by an objective lens module at twentyfold magnification when a light source imaging coincides with a center of a Spiral Phase Plate (SPP) according to some embodiments of the present disclosure; FIG. 16 is a schematic diagram illustrating an image of a tumor cell sample observed by an objective lens module at twentyfold magnification when a light source imaging coincides with a center of a Sample Focal Plane (SPP) according to some embodiments of the present disclosure.

Merely by way of example, as shown in FIG. 14, when an image is observed in a bright field (i.e., a micrograph with planar visual effect), the detailed textures of a transparent sample are not obvious at the same magnification, and the contrast of the cellular image is poor; when an image of the light source coincides with (i.e., centering) a center of the phase modulation unit 530 (i.e., a spiral phase plate), the details of edges of the transparent sample are enhanced; and when the image of the light source deviates from (i.e., decentration) the phase modulation unit 530, the details of the transparent sample are contrasted with the background obviously, and a relief imaging effect image is formed. As shown in FIG. 15 and FIG. 16, when the image of the light source coincides with the center of the phase modulation unit 530 at different magnifications, the details of edges of the transparent sample are enhanced at different magnifications.

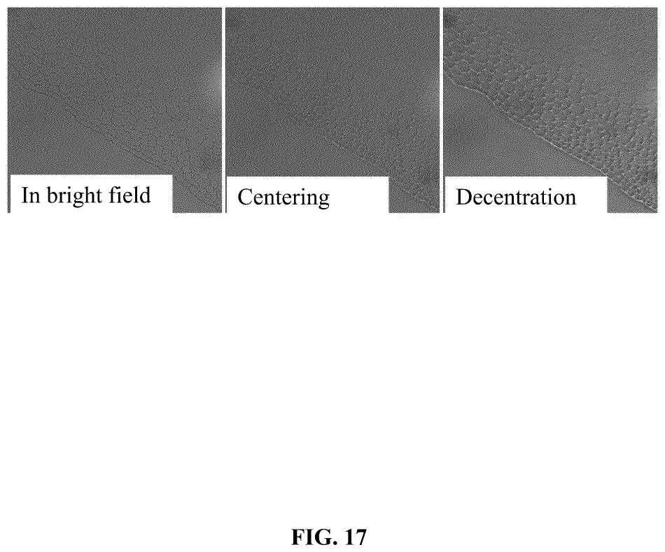

FIG. 17 is a schematic diagram illustrating a comparison of an unstained plant rhizome slice observed by an objective lens module at tenfold magnification according to some embodiments of the present disclosure.

Merely by way of example, as shown in FIG. 17, when an image is observed in the bright field image, the detailed textures of a transparent sample are not obvious at the same magnification, and a flat layer appears as a black network; when the image of the light source coincides with a center of the phase modulation unit 530, the details of edges of the transparent sample are enhanced; when the image of the light source deviates from the center of the phase modulation unit 530, the details of the transparent sample are contrasted with the background obviously, a relief imaging effect is formed.

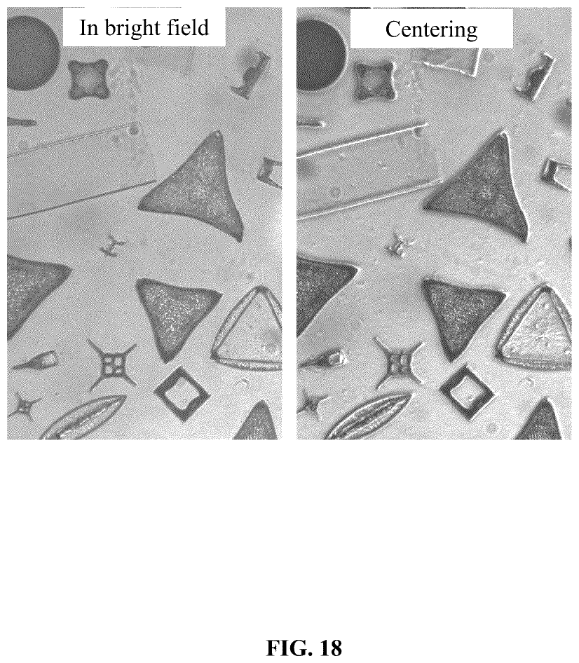

FIG. 18 is a schematic diagram illustrating a comparison of a diatom sample observed by an objective lens module at tenfold magnification according to some embodiments of the present disclosure.

Merely by way of example, since the diatom sample itself has a certain thickness, the stereoscopic sense is stronger when observed using the objective lens module in the embodiment.

As shown in FIG. 18, when an image is observed in a bright field, the detailed textures of a transparent sample are not obvious at the same magnification; the details of edges of the transparent sample are enhanced when a light source imaging coincides with a center of the phase modulation unit 530 (i.e., a spiral phase plate).

In some embodiments, as shown in FIG. 13, the objective lens module 500 may include a first adjustment mechanism 540 connected to the phase modulation unit 530; wherein the first adjustment mechanism 540 is configured to adjust a position of the phase modulation unit 530 based on user operation, enabling a center of the phase modulation unit 530 to coincide with or deviate from an image of the light source on the plane containing the phase modulation unit 530.

In some embodiments, the objective lens module 500 may further include a third adjustment mechanism 550, connected to the phase modulation unit 530 and configured to adjust a position of the phase modulation unit 530 along an optical axis of the objective lens module 500 based on user operation.

The reason for setting the third adjustment mechanism and the specific setting form of the third adjustment mechanism may be found in the previous embodiments, which are not repeated here.

In some embodiments, the objective lens module 500 may further include both the first adjustment mechanism and the third adjustment mechanism, which can better achieve the desired phase contrast imaging effect while ensuring the reliability of the objective lens module 500.

The first adjustment mechanism 540 has the same or similar structure and function as the first adjustment mechanism 160, and more descriptions may be found in the related descriptions in FIG. 7; and the third adjustment mechanism 550 has the same or similar structure and function as the third adjustment mechanism 180, and more descriptions may be found in the related descriptions in FIG. 9.

Some embodiments of the present disclosure provide a combination of elements.

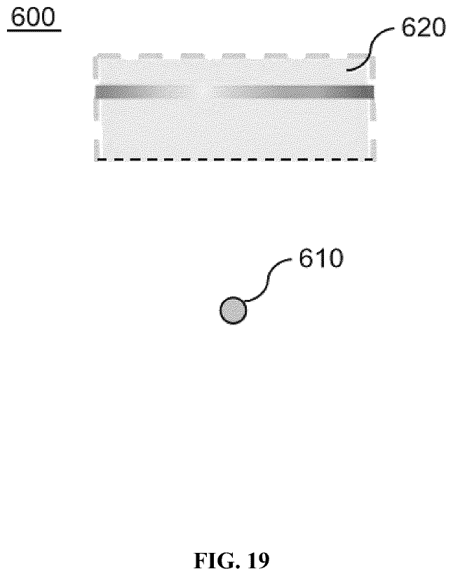

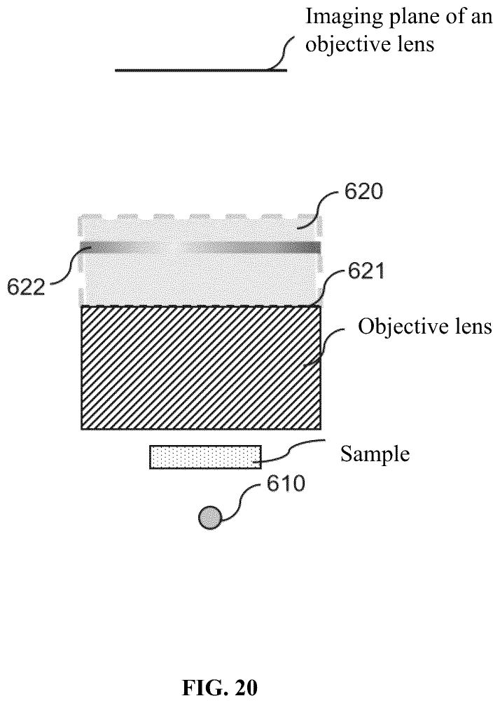

FIG. 19 is a schematic diagram illustrating a combination of elements according to some embodiments of the present disclosure; FIG. 20 is a schematic diagram illustrating a structure of a combination of elements coordinating with an objective lens according to some embodiments of the present disclosure.

In some embodiments, as shown in FIG. 19 and FIG. 20, a combination of elements 600 includes: a light source 610, configured to provide light for illuminating a sample; and an external module 620, including a connecting portion 621, wherein the connecting portion 621 is connected to an objective lens; wherein the external module 620 further includes a phase modulation unit 622, when the external module 620 is connected to the objective lens via the connecting portion 621, the phase modulation unit 622 is configured to modulate light exiting from the objective lens and obtain a desired sample image on an imaging plane of an objective lens module that incorporates the objective lens; wherein a plane containing the phase modulation unit 622 and a plane containing the light source 610 form a pair of conjugate planes and at least an optical path between the plane containing the phase modulation unit 622 and an imaging plane of the objective lens module introduces no lens or lens group performing a Fourier transform.

The external module 620 refers to a module provided external to the objective lens for modulating the light. The connecting portion is configured to connect two structures, e.g., connecting the external module 620 and the objective lens. Merely by way of example, the connecting portion may be one of a threaded structure, a snap structure, a magnetic structure, etc.

The understanding of “conjugate” and “an optical path between the plane containing the phase modulation unit 622 and an imaging plane of the objective lens module introduces no lens or lens group performing a Fourier transform” is similar to that described above, which may be found in the embodiments above.

The combination of elements 600 can achieve a substantially uniform imaging effect as that of the spiral phase difference objective lens by providing the light source 610 and the external module 620 provided with the phase modulation unit 622, and illuminating the sample with the light source 610, and connecting the external module 620 to the exit end of the light of the objective lens to achieve the same imaging effect as the spiral phase contrast objective lens, i.e., there is no need to modify the original objective lens or purchase an additional spiral phase contrast objective lens or a mid-range or high-end phase contrast microscope, which greatly reduces the cost.

Merely by way of example, the light source 610 includes a parallel light source or a point light source. Merely by way of example, when the light source 610 is the parallel light source, the plane containing the phase modulation unit 622 coincides with a back focal plane of the objective lens.

Merely by way of example, the imaging plane of the objective lens module may be the image plane that forms an image of the sample by observing the sample utilizing the entire lens system including the objective lens. In other words, the objective lens module may be provided with only the objective lens, and may further include other lenses in addition to the objective lens.

In some embodiments, the phase modulation unit 622 includes a spiral phase plate, and the external module 620 further includes a first adjustment mechanism connected to the phase modulation unit 622; wherein the first adjustment mechanism is configured to adjust a position of the phase modulation unit 622 within a plane containing the phase modulation unit 622 based on user operation, enabling a center of the phase modulation unit 622 to coincide with or deviate from an image of the light source 610 on the plane containing the phase modulation unit 622. In this way, through the first adjustment mechanism, when the image of the light source 610 in the plane containing the phase modulation unit 622 coincides with the center of the phase modulation unit 622, an edge-enhanced phase contrast micrograph can be obtained; when the image of the light source 610 on the plane containing the phase modulation unit 622 deviates from the center of the phase modulation unit 622, and the center of the phase modulation unit 622 is still located on the plane containing the phase modulation unit 622, a phase contrast micrograph with relief effect may be obtained. The specific setting form of the first adjustment mechanism may be found in the previous embodiments, which is not repeated here.

In some embodiments, the external module 620 further includes a third adjustment mechanism, connected to the phase modulation unit 622 and configured to adjust a position of the phase modulation unit 622 along the optical axis of the objective lens based on user operation. The reason for setting the third adjustment mechanism and the specific setting form of the third adjustment mechanism may be found in the previous embodiments, which is not repeated here.

In some embodiments, since the parallel light source is mostly used for illuminating the sample in the original optical path, the plane containing the phase modulation unit 622 (i.e., the plane conjugate to the plane containing the light source) and the back focal plane of the objective lens are unified, and in addition, the position where the phase modulation unit 622 is located along the direction of the optical axis has a certain tolerance degree, which is basically located between the back focal plane of the objective lens and the plane conjugate to the plane containing the light source 610.

In some embodiments, as shown in FIG. 20, when the external module 620 is connected to the objective lens via the connecting portion 621, the plane containing the phase modulation unit 622 coincides with the back focal plane of the objective lens.

Such a setup ensures the desired imaging effect and facilitates the preparation of the objective lens module 500, and the above setup is applicable to most of the original microscopes, which is conductive to achieving industrialization.

Some embodiments of the present disclosure provide an external module, and the external module may be applied to the combination of components described above.

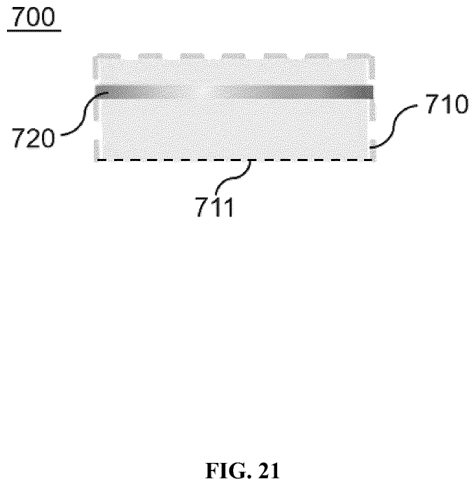

FIG. 21 is a schematic diagram illustrating a structure of an external module according to some embodiments of the present disclosure.

In some embodiments, as shown in FIG. 21, the external module 700 includes a housing 710 configured to accommodate a phase modulation unit 720, and the housing 710 is arranged with a connecting portion 711. More descriptions regarding the connecting portion may be found in the related descriptions in FIG. 19 and FIG. 20.

The external module 700, when assembled to an objective lens, enables a plane containing the phase modulation unit 720 conjugate to a plane containing a light source, thereby achieving a desired phase contrast imaging effect. On the other hand, for an imaging optical path that has been configured with the light source, the external module 700 can be directly assembled to the objective lens, thereby obtaining the desired phase contrast imaging effect.

Some embodiments of the present disclosure further provide an external imaging module. The external imaging module may be used in conjunction with the objective lens to capture an image of a transparent sample through a camera.

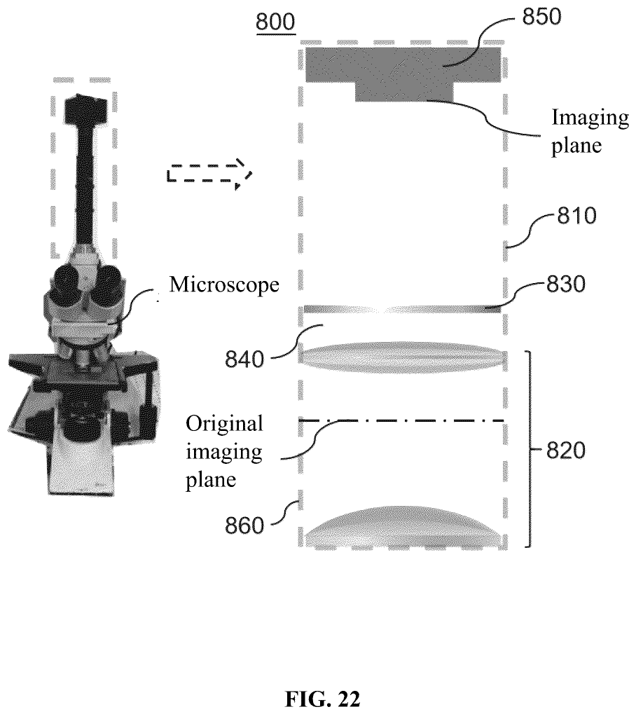

FIG. 22 is a schematic diagram illustrating a structure of an external imaging module according to some embodiments of the present disclosure.

In some embodiments, as shown in FIG. 22, the external imaging module 800 includes: a housing 810; an imaging lens group 820, arranged within the housing 810 and configured to receive light exiting from an objective lens to image a sample for a second time or more than a second time sequentially; wherein the objective lens is configured to receive the light of a light source illuminating the sample and exiting from the sample to perform a first image on the sample; a phase modulation unit 830, arranged within the housing 810 and configured to modulate the light emitting from the imaging lens group 820 to form a desired sample image on an imaging plane of the external imaging module 800; wherein a plane containing the phase modulation unit 830 is conjugate to a plane containing the light source, and at least the optical path between the plane containing the phase modulation unit 830 and the imaging plane of the external imaging module 800 introduces no lens or lens group performing a Fourier transform. More descriptions regarding the imaging lens group may be found in the related descriptions in FIG. 1.

The understanding of “conjugate” and “the optical path between the plane containing the phase modulation unit 830 and an imaging plane of the external imaging module 800 introduced into the optical path between the plane of the phase modulation unit 830 to perform a Fourier transform” is similar to that described above, which may be found in the embodiments above.

During imaging, the light exiting from the objective lens may be incident into the external imaging module 800 after the first imaging, and the external imaging module 800 the external imaging module 800 performs secondary or higher-order imaging on sample, wherein the light carrying sample information reaches the imaging plane of the external imaging module 800 ultimately after exiting from the imaging lens group 820 and phase modulation unit 830 sequentially.

Merely by way of example, “the external imaging module 800 performs secondary or higher-order imaging on sample” means that: when the external imaging module 800 is directly adjacent to the objective lens, the optical path between the objective lens and the external imaging module 800 does not introduces other lenses, and at the same time, the external imaging module 800 perform a secondary imaging on the sample; and when other lenses are introduced in the optical path between the objective lens and the external imaging module 800, the other lenses perform the secondary imaging, a tertiary imaging, a quaternary imaging on the sample, and at the same time, the external imaging module 800 performs the tertiary imaging or the quaternary imaging on the sample.

The external imaging module 800 can add an additional imaging optical path behind the original imaging optical path, provide the phase modulation unit in the additional imaging optical path, and enable the plane containing the phase modulation unit and the plane containing the light source to form a pair of conjugate planes, which can achieve more imaging effects without modifying the original imaging optical path. In addition, at least the optical path between the plane containing the phase modulation unit 830 and the imaging plane of the external imaging module introduces no lens or lens group performing a Fourier transform, which may avoid negative effects such as a decrease in the imaging resolution due to adding the additional lens and an increase in the optical aberration, thereby improving the imaging quality.

In some embodiments, as shown in FIG. 22, a connecting portion 860 is provided on the housing 810, and the connecting portion 860 is connected to a photographic port of the microscope. With continued reference to FIG. 1, the photographic port of the microscope is an original imaging plane, the external imaging module 800 is added at the photographic port to make the original imaging plane as an intermediate image, and the intermediate image may be projected to another distant imaging plane to be captured by the camera. At the time, the external imaging module 800 performs a last imaging on the sample. There is no impact on the original imaging optical path by providing up a new imaging optical path in the photographic port of the microscope.

In some embodiments, with continued reference to FIG. 22, the external imaging module 800 includes a photosensitive element 850, wherein a photosensitive surface of the photosensitive element 850 coincides with the imaging plane of the external imaging module 800. A microscopic phase contrast image of a transparent sample can be captured by providing the photosensitive element 850 on the imaging plane of the external imaging module 800.

In some embodiments, with continued reference to FIG. 22, the housing 810 is provided with an optical aperture 840, and the optical aperture 840 extends in a direction from an end of the housing 810 to the optical axis of the external imaging module 800, wherein the imaging lens group 820 and the phase modulation unit 830 are both connected to the a wall of the optical aperture 840. The external imaging module 800 is conveniently disassembled and assembled by integrating the imaging lens group 820 and the phase modulation unit 830 in a single module.

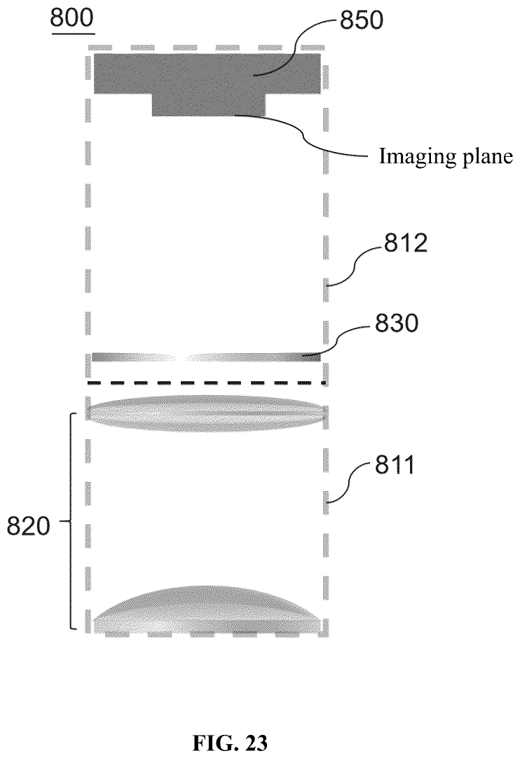

FIG. 23 is another schematic diagram illustrating a structure of an external imaging module according to some embodiments of the present disclosure.

In some embodiments, as shown in FIG. 23, the housing 810 includes a first housing 811 and a second housing 812 that are detachably connected, wherein the imaging lens group 820 is arranged within the first housing 811, the phase modulation unit 830 is arranged within the second housing 812. In the way, the external imaging module 800 can be divided into at least two independent modules, thereby facilitating the cleaning of the external imaging module 800, and when one of the at least two independent modules is damaged, it is only necessary to replace the damaged module without replacing all of the modules, so as to reduce maintenance costs.

In some embodiments, the plane containing the phase modulation unit 830 coincides with the back focal plane of the imaging lens group 820. Since the position where the phase modulation unit 830 is located along the direction of the optical axis has a certain tolerance degree, the position of the phase modulation unit 830 is substantially positioned between the back focal plane of the imaging lens group 820 and a plane conjugate to the plane containing the light source. In summary, the back focal plane of the imaging lens group 820 is adopted as the position of the phase modulation unit 830 in the external imaging module 800, which not only ensures the desired imaging effect, but also facilitates the preparation of the external imaging module 800, which is conductive to achieving industrialization.

In some embodiments, the phase modulation unit 830 includes a spiral phase plate. When an image of the light source on the plane containing the spiral phase plate coincides with a center of the spiral phase plate, a phase contrast micrograph with edge enhancement may be obtained; when the image of the light source on the plane containing the spiral phase plate deviates from the center of the spiral phase plate and the center of spiral phase plate is still located on the plane containing the spiral phase plate, and a phase contrast micrograph with a relief effect may be obtained.

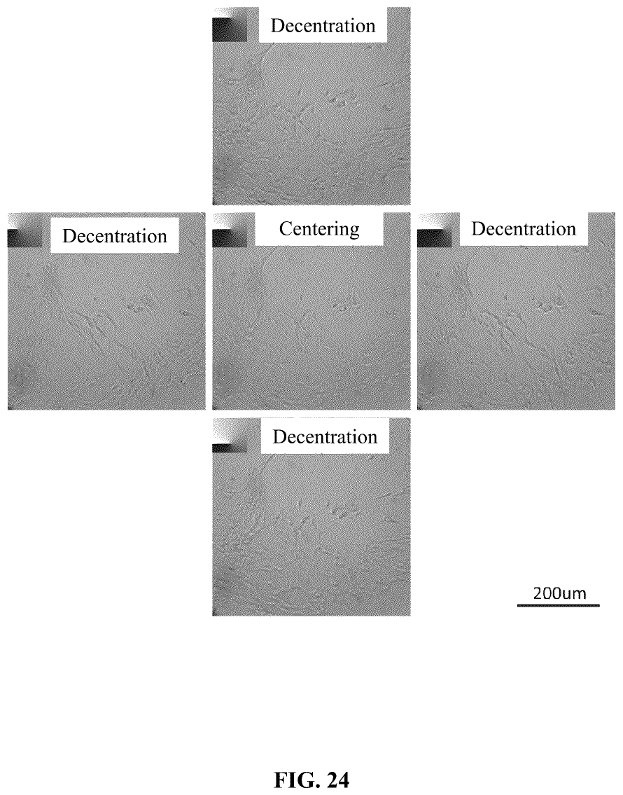

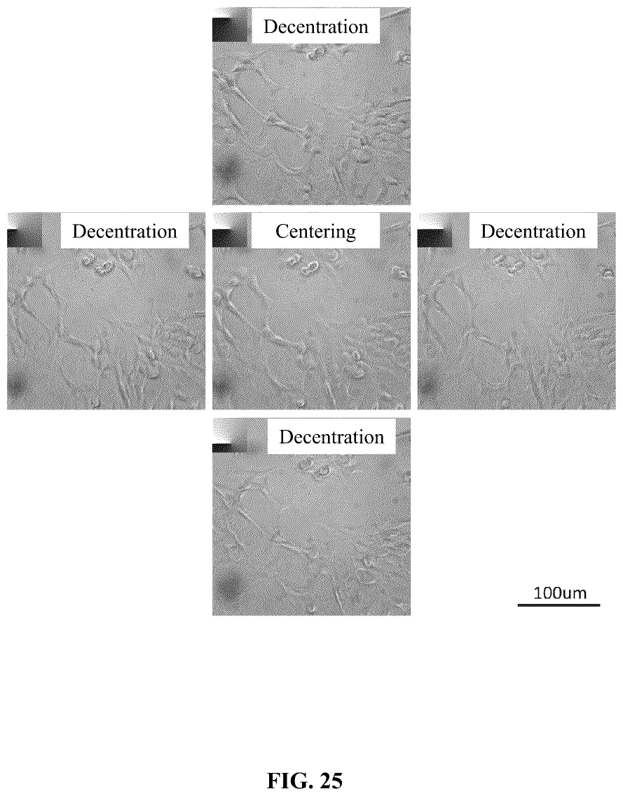

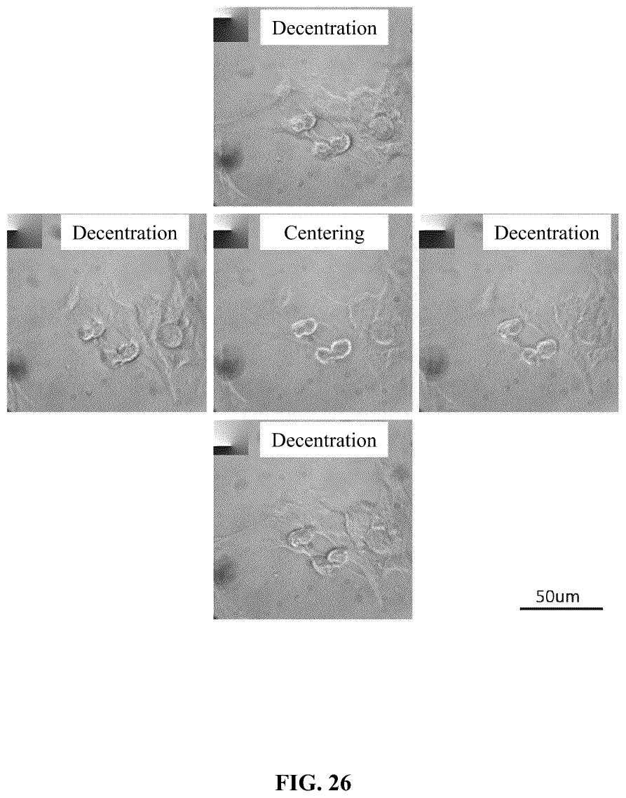

FIG. 24 is another schematic diagram illustrating a comparison of phase-contrast micrographs at tenfold magnification according to some embodiments of the present disclosure; FIG. 25 is another schematic diagram illustrating a comparison of phase-contrast micrographs at twentyfold magnification according to some embodiments of the present disclosure; FIG. 26 is a schematic diagram illustrating a comparison of phase-contrast micrographs at fiftyfold magnification according to some embodiments of the present disclosure.

Merely by way of example, as shown in FIGS. 24, 25, and 26, at different magnifications; when an image of a light source coincides with (i.e., centering) a center of a phase modulation unit 830 (i.e., a spiral phase plate), details of edges of a transparent sample are enhanced; and when the light source imaging deviates from the center of the phase modulation unit 830, the details of the transparent sample exhibit an obvious relief imaging effect.

In some embodiments, in order to achieve change of a relative position between the image of the light source on the plane containing the phase modulation unit 830 (i.e., the spiral phase plate) to the center of the phase modulation unit 830, the external imaging module 800 may include a first adjustment mechanism connected to the phase modulation unit 830, and is configured to change a position of the phase modulation unit 830 within the plane containing the phase modulation unit 830 based on user operation, enabling the center of the phase modulation unit 830 coincide with or deviate from the image of the light source on plane containing the phase modulation unit 830. The first adjustment mechanism has the same or similar structure and function as the first adjustment mechanism 160, and more descriptions may be found in FIG. 7.

In some embodiments, the external imaging module 800 may further include a third adjustment mechanism, wherein the third adjustment mechanism is connected to the phase modulation unit 830, and configured to adjust a position of the phase modulation unit 830 along an optical axis of the external imaging module 800 based on user operation. The reason for setting the third adjustment mechanism and the specific setting form of the third adjustment mechanism may be found in the previous embodiments, which is not repeated here.

In some embodiments, the external imaging module 800 may further include both the first adjustment mechanism and the third adjustment mechanism to better achieve the desired phase contrast imaging effect while ensuring the reliability of the external imaging module 800.

Merely by way of example, some other embodiments of the present disclosure provide a combination of elements 900. The combination of elements 900 is applied to a microscope.

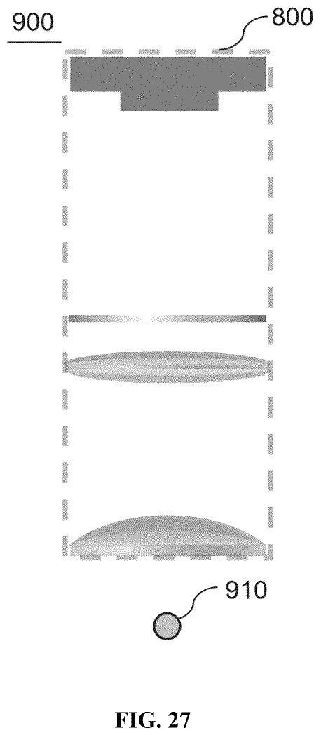

FIG. 27 is another schematic diagram illustrating a structure of a combination of elements according to some embodiments of the present disclosure.

In some embodiments, as shown in FIG. 27, the combination of elements 900 includes: a light source 910, configured to provide light illuminated to the sample; and the external imaging module 800 as previously described.

The above combination of elements 900 provides a light source 910 and an external imaging module 800 provided with a phase modulation unit 830, and enables the light source to illuminate the sample, so that the desired phase contrast imaging effect can be achieved by external imaging module 800, which does not need to modify the original objective lens or purchase a mid-to-high-end phase contrast microscope, thereby greatly reducing the cost.

It should be understood that the above embodiments are exemplary and are not intended to encompass all possible embodiments encompassed by the claims. Various deformations and changes can also be made based on the above embodiments without departing from the scope of the present disclosure. Similarly, any combination of the various technical features of the above embodiments may be made to form additional embodiments of the present disclosure that may not be expressly described. The above embodiments therefore express only several embodiments of the present disclosure, and do not limit the scope of protection of the patent of the present disclosure.

What is claimed is:

1. An imaging system, wherein the imaging system, arranged along an optical axis from an object side to an image side, comprises:
a light source, configured to provide light for illuminating a sample;
an imaging lens group, configured to receive the light exiting from the sample and perform at least one imaging for the sample; and
a phase modulation unit, configured to modulate the light exiting from the imaging lens group, and obtain a desired sample image at an imaging plane of the imaging system.

2. The imaging system of claim 1, wherein a plane containing the phase modulation unit and a plane containing the light source form a pair of conjugate planes; and, at least an optical path between the plane containing the phase modulation unit and the imaging plane of the imaging system introduces no lens or lens group performing a Fourier transform.

3. The imaging system of claim 2, wherein the phase modulation unit is adjacent to the imaging plane of the imaging system.

4. The imaging system of claim 2, wherein the imaging system further includes:
a first housing configured to accommodate the imaging lens group; and
a second housing configured to accommodate the phase modulation unit;
wherein the first housing and the second housing are integrally formed or detachably connected.

5. The imaging system of claim 1, wherein the phase modulation unit includes a spiral phase plate.

6. The imaging system of claim 5, wherein the imaging system further includes:
a first adjustment mechanism connected to the phase modulation unit;
wherein the first adjustment mechanism is configured to adjust a position of the phase modulation unit within a plane containing the phase modulation unit based on user operation, enabling a center of the phase modulation unit to coincide with or deviate from an image of the light source on the plane containing the phase modulation unit.

7. The imaging system of claim 5, where the imaging system further includes:
a front lens, arranged between the light source and the imaging lens group and configured to converge the light exiting from the front lens; and
a second adjustment mechanism connected to the front lens;
wherein the second adjustment mechanism is configured to adjust a position of the front lens based on user operation, enabling an image of a convergence point formed by the light emitted from the light source imaging on the plane containing the phase modulation unit after passing through the front lens to coincide with or deviate from a center of the phase modulation unit.

8. The imaging system of claim 7, wherein the imaging system further includes:
a filter, arranged between the front lens and the imaging lens group and configured to filter the light exiting from the front lens before the light illuminates the sample.

9. The imaging system of claim 1, wherein the imaging system further includes:
a third adjustment mechanism, connected to the phase modulation unit and configured to adjust a position of the phase modulation unit along the optical axis based on user operation.

10. The imaging system of claim 1, wherein the imaging system has a target plane conjugate to a plane containing the light source, a plane containing the phase modulation unit is arranged between a back focal plane of the imaging lens group and the target plane; and, at least an optical path between a plane containing the phase modulation unit and the imaging plane of the imaging system introduces no lens or lens group performing a Fourier transform.

11. The imaging system of claim 1, wherein a plane containing the phase modulation unit and a plane containing the light source form a pair of conjugate planes; and, the plane containing the phase modulation unit is adjacent to an imaging plane of the imaging system.

12. The imaging system of claim 1, wherein a plane containing the phase modulation unit and a plane containing the light source form a pair of conjugate planes; and, an intermediate lens group is arranged between the plane containing the phase modulation unit and an imaging plane of the imaging system, and a back focal plane of the intermediate lens group deviates from the imaging plane.

13. An image acquisition device, comprising an imaging system of claim 1 and a photosensitive element, wherein a photosensitive surface of the photosensitive element coincides with an imaging plane of the imaging system.

14. An objective lens module, comprises:
a housing;
an imaging lens group, arranged within the housing and configured to receive light exiting from a sample and perform at least one imaging for the sample;
a phase modulation unit, arranged within the housing and configured to modulate the light emitted by a light source and light exiting from the imaging lens group and obtain a desired sample image at an imaging plane of the objective lens module;
wherein
a plane containing the phase modulation unit and a plane containing the light source form a pair of conjugate planes, and at least an optical path between the plane containing the phase modulation unit and an imaging plane of the imaging system introduces no lens or lens group performing a Fourier transform.

15. The objective lens module of claim 14, wherein
the housing includes an entrance end of the light, an exit end of the light, and an optical aperture penetrating through both the entrance end of the light and the exit end of the light along an optical axis of the objective lens module;
wherein
the imaging lens group and the phase modulation unit are connected to a wall of the optical aperture.

16. The objective lens module of claim 14, wherein the phase modulation unit includes a spiral phase plate.

17. The objective lens module of claim 15, wherein the objective lens module further includes:
a first adjustment mechanism connected to the phase modulation unit;
wherein the first adjustment mechanism is configured to adjust a position of the phase modulation unit within a plane containing the phase modulation unit based on user operation, enabling a center of the phase modulation unit to coincide with or deviate from an image of the light source on the plane containing the phase modulation unit.

18. The objective lens module of claim 14, wherein the objective lens module further includes:
a third adjustment mechanism, connected to the phase modulation unit and configured to adjust a position of the phase modulation unit along the optical axis of the objective lens module based on user operation.

19. A combination of elements, comprises:
a light source, configured to provide light for illuminating a sample; and
an external module, including a connecting portion, wherein the connecting portion is connected to an objective lens;
wherein the external module further includes a phase modulation unit,
when the external module is connected to the objective lens via the connecting portion, the phase modulation unit is configured to modulate light exiting from the objective lens and obtain a desired sample image on an imaging plane of an objective lens module that incorporates the objective lens; wherein a plane containing the phase modulation unit and a plane containing the light source form a pair of conjugate planes and at least an optical path between the plane containing the phase modulation unit and an imaging plane of the objective lens module introduces no lens or lens group performing a Fourier transform.

20. An external module, wherein the external module applies to a combination of claim 19, the external module includes a housing configured to accommodate the phase modulation unit, and the housing is arranged with a connecting portion.
